(19) United States
(12) Patent Application Publication
(10) Pub. No.: US 2009/0289107 A1
(43) Pub. Date: Nov. 26, 2009

(54) MULTI-USE DURABLE GOODS CARD AND SYSTEM

(76) Inventor: Wayne Douglas Prentice, Goleta, CA (US)

Correspondence Address: Wayne D. Prentice, 8479 Vereda Del Padre, Goleta, CA, 93117, US

(21) Appl. No.: 12/126,975

(22) Filed: May 26, 2008

(51) Int. Cl. G06K 19/07; G06K 5/00

(52) U.S. Cl. 235/380; 235/493; 235/492

(57) ABSTRACT

A card, system, and methods for the present invention: the Multi-Use Durable Goods (MDG) Card having multiple features, such as integrated circuit chips, RFID circuitry, magnetic stripe, holographic foil, photograph and text; provides a customer with a primary use as a registry title card which can be further activated to have a secondary use as a credit card. The MDG card can be activated as a registry title card, registering title, monitor ownership equity and brand equity to durable goods; and as a transaction card with a credit card feature. Activation of the MDG card as a registry title card, allows the customer to purchase unique and documented durable goods (for example a gemstone with Gemological Trade Laboratory Report) from a vendor to establish transfer of ownership of the durable good, maintain provenance, documentation, equity values and credit. Activation of the MDG card credit feature allows the customer to interact with any merchant that accepts traditional credit cards such as VISA®, MASTERCARD®, AMERICAN EXPRESS®, or DISCOVER®. The combination of MDG card features allows a customer to purchase a durable good, maintain provenance, equity and credit, upon the activation of both manners described above; and the Multi-Use Durable Goods (MDG) Card is a security financial instrument.

### FIELD OF INVENTION

The present invention generally relates to transaction and payment cards, including registry card, credit cards, bank cards, and the like, and more particularly to a registry card or payment card which can be activated to have an alternative or secondary use as a credit card by adding credit card feature; system and methods of using such a card in contact and contactless transactions.

### BACKGROUND OF INVENTION

Many durable goods, such as gemstones, with intrinsic value have stable utility value over time independent of any single currency, and are globally traded amongst professionals in their respective fields. In the gem industry, gemstones such as certificated diamonds, documented by gemological reports from recognized gem trade laboratories, are globally traded in the billions of dollars annually, but only amongst professionals in the jewelry industry and in United States Dollars. The end user, which is typically the retail consumer, has limited means to determine their good's intrinsic value, the good's current value in a currency or other currencies, or access to any of the good's intrinsic value except through a sale, through which they would loose possession, value or any potential gains of value in the future.

Durable goods of limited supply, increasing demand, of high value, easily transportable and globally traded are also readily used to transporting wealth between countries, legally and illegally. Many countries today may have passed anti-money laundering and anti-terrorism legislation requiring declarations and documentation when goods pass through customs of each country, but once in the country a retail consumer generally has no means to verify a good's origin or a good's chain of ownership history. For example, in the trade of diamonds, customs utilize a certification scheme (The Kimberley Process) for documentation and monitoring the origin and trade of rough (crystals) diamonds, but certification does not follow with the polished diamonds when cut, sold to the retail consumer or subsequent sales. Consumers therefore typically rely solely on brand, a brand's integrity or on an individual's integrity, which may not be known at the point of sale. Until now, a consumer has no means to verify origin or chain of title/ownership at original point of sale or subsequent sales of a durable good.

A durable good's intrinsic value is too often hidden to the consumer: where intrinsic value represents the value at which global demand is being fulfilled by global supply of the durable good. When a durable good's global reference is pegged to a single country's currency, such as diamonds are currently pegged to U.S. Dollar, if the “pegged” currency drops in its utility value, devalues or becomes unstable, the intrinsic value of the durable good is accordingly misrepresented or a time lag created before value stated in currency can adjust back through active trading in the global marketplace. When considering a currency's devaluation can be demonstrated by ever increasing prices paid for commodities possessing stable utility value, such as silver, gold and oil which are traded actively daily worldwide; one concludes silver, gold and even oil's intrinsic value have changed very little over time, only the reference used to them. For example, one-quarter ounce of silver in the mid-1960s was equivalent to one gallon of gasoline at 25 cents/gallon in the United States, which is still true over 44 years later with silver trading at $18/ounce and the price of a gallon of gas at the pump is $4.20/gallon. Until now, prices of many durable goods have not kept pace with changes of the currency used.

The global economy and marketplace is fast becoming very integrated, through technology, banking, the internet, travel and advances in communications, but yet durable goods with intrinsic value currently lack an international format or system for recording and maintaining ownership equity. Until now, there has been no system for registering ownership or a system and methodology, through which to easily transfer ownership or to create a lien specific to a durable good. Many durable goods, such as diamonds may possess extremely high intrinsic value convertible to any currency worldwide, but yet most owners of durable goods do not have access to that value.

### SUMMARY OF INVENTION

In view of the foregoing, it is an object of the present invention to provide a system for a multiple function registry and transaction card, as it relates to a contact and contactless card, system and methods of using the same. The Multi-Use Durable Goods (MDG) Card is a smart card and system that functions in four areas: I.) as a registry card: registering a durable good, which may comprise of recording specification(s), documentation(s), brand, title/ownership, chain of title/ownership, and liens on said durable good; II.) value monitoring for said durable good's: intrinsic value, global market value, local currency conversion, ownership equity, liens stated in intrinsic value, liens stated in local currency, credit line, and balance of credit line; III.) as a payment card: such as a credit card, bank card, or other payment card; IV.) as a security instrument on said durable good: such as a security interest, a hypothec, a hypothecation, trust receipt, pledge, a chattel mortgage, trust receipt, pawn, trust deed, or deed. The MDG card and system of the present invention, provides a legitimate and secure means by which to integrate durable goods with the global marketplace, networks and banking system.

### DETAILED DESCRIPTION

The present invention relates to a multiple function registry and transaction card, system and methods of using the same. Specifically, the primary use as a registry card maintains a secure registry of title, specifications, documentation and value reference for a durable good and the secondary use as a transaction card as a credit card thereby creating lien on title. The MDG card (101) may include multiple features, such as integrated circuit chips, RFID circuitry, magnetic stripe, holographic foil, text and others features in a plurality of layers. The MDG card may include means for conducting a transaction in a contactless environment. For example, the transaction card may include a transponder system, which may include a RF-based chip and antenna embedded therein. The contactless transaction card can be utilized to more efficiently conduct cashless transactions at merchants, for example, a merchant POS, by permitting the cardholder to maintain possession of the card throughout the transaction. The contactless registry card can be utilized to more efficiently conduct communication data with a registry host network, or other network, by permitting the card holder to maintain possession of the card. In addition, the transaction card may further include a traditional magnetic stripe so that the transaction card can alternatively be fed through a magnetic stripe reader or inserted in a card acceptance device for transaction completion or communication to registry host network, or other network.

FIG. 1 illustrates an exemplary MDG card system (100) in accordance with the present invention, in accordance with exemplary components for use in completing, a contact and/or Radio Frequency (RF) contactless multi-use registry card and transaction card, registration and transaction are depicted. In general, the operation of system (100) may begin when a MDG card (101) is presented to register a good or for payment. An RFID reader (102) or Reader (103) which may provide an interrogation signal for powering the MDG card (101), then interrogates the card. The MDG card (101) and reader (102 or 103) may then engage in “mutual authentication” after which the MDG card (101) may provide a transponder identifier and/or account identifier to the reader (102 or 103) which may further provide the identifier to the system (115 or 116) POS Device (106).

It should be noted that although the present invention is described herein with reference to including only one RFID transponder system, one RFID or IC chip, the invention is not so limited. The invention contemplates the inclusion of one or more RFID transponder systems, IC chips or modules, or any combination thereof.

The RFID reader (102) may be configured to communicate using a RFID internal antenna (104). Alternatively, RFID reader (102) may include an external antenna (105) where the external antenna (105) may be made remote to the RFID reader (102) using a suitable cable and/or data link (111). RFID reader (102) may be further in communication with a registry system and/or transaction completion system (e.g., Registry Host Network (115) and/or Merchant Host Network (116)) via a data link 112.

In one exemplary embodiment the MDG card system (100) may include POS device (106) in communication with reader 102 or 103 (via data link 110), and a customer interface (108) in communication with the POS device (106) via data link 114.

Although the point of interaction device is described herein with respect to a point of sale (POS) device, the invention is not to be so limited. Indeed, a POS device is used herein by way of example, and the point of interaction device may be any device capable of receiving card account data. In this regard, the POS may be any point of interaction device or card acceptance device enabling the user to complete a registry or transaction.

POS device (106) may be in further communication with a customer interface (108) (via data link 114) for entering at least an alternate customer identity verification information such as, for example, a person identification number. POS device (106) may also be in communication with the registry or merchant host networks (107, 109) (via data link 112) for processing any registry or transaction request. In this arrangement, information provided by reader (102 or 103) is provided to the POS device (106) of the registry and merchant systems (115, 116) via data link (110). The POS device (106) may receive the information (and alternatively may receive any identity verifying information from customer interface (108) via data link 114) and provide the information to host system (107 or 109) for processing.

A variety of conventional communications media and protocols may be used for data links 110, 111, 112, and 114. For example, data links 110, 111, 112, and 114 may be an Internet Service Provider (ISP) configured to facilitate communications over a local loop as is typically used in connection with standard modem communication, cable modem, dish networks, ISDN, Digital Subscriber Lines (DSL), or any wireless communication media. In addition, the registry and merchant systems (115, 116) including the POS device (106) and host networks (107, 109) may reside on a local area network which interfaces to a remote network (not shown) for remote authorization of an intended transaction. The registry and merchant systems (115,116) may communicate with the remote network via a leased line, such as a T1, D3 line, or the like.

An account number, as used herein, may include any identifier for an account which may be maintained by a registry account and/or transaction account provider (e.g., payment authorization center) and which may be used to complete a financial transaction. A typical account number (e.g., account data) may be correlated to a registry or credit account maintained and serviced by such entities as American Express, Visa and/or MasterCard or the like. For ease in understanding, the present invention may be described with respect to a registry account and credit account. However, it should be noted that the invention is not so limited and other accounts permitting an exchange of goods and services for an account data value is contemplated to be within the scope of the present invention (e.g., barter account, rewards or points account).

In addition, the account number (e.g., account data) may be associated with any device, code, or other identifier/indicia suitably configured to allow the consumer to interact or communicate with the system, such as, for example, authorization/access code, personal identification number (PIN), Internet code, digital certificate, biometric data, and/or other identification indicia. The account number may be optionally located on the registry card, credit card, charge card, smart card, magnetic stripe card, bar code card, and/or the like. The account number may be distributed and stored in any form of plastic, electronic, magnetic, and/or optical device capable of transmitting or downloading data to a second device. A customer account number may be, for example, a sixteen-digit credit card number, although each registry provider and credit provider has its own numbering system, such as the sixteen-digit numbering system used by Mastercard. Each company's registry card and credit card numbers comply with that company's standardized format such that the company using a sixteen-digit format will generally use four spaced sets of numbers, as represented by the number “0000 0000 0000 0000”. In a typical example, the first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer. The account number stored as Track 1 and Track 2 data as defined in ISO/IEC 7813, and further may be made unique to MDG card (101). In one exemplary embodiment, the account number may include a unique card serial number and user identification number. The account number may be stored in MDG card (101) inside a database 206 (shown in FIG. 2) as described more fully below. Database (206) may be configured to store multiple account numbers issued to the MDG card (101) user by the same or different account providing institutions. Where the account data corresponds to a registry account, the database (206) may be configured to store the good's value data.

FIG. 2 illustrates a block diagram of the many functional blocks of MDG card (101) circuitry, in accordance with an exemplary embodiment of the present invention. MDG card (101) may include one or more transponder responsive to RF interrogation by an RFID reader (102). As described herein, by way of example, the MDG card (101) may include an RFID circuitry which may facilitate contactless registration of a good and/or payment for goods and/or services.

In one exemplary embodiment, MDG card (101) may include an antenna (201) for receiving the RF interrogation signal from the RFID reader (102) via antenna (104 or alternatively, via external antenna 105). Card antenna (201) may be in communication with a transponder (118). Where multiple antennas are included as part of the card internal circuitry, such as, where the card includes multiple transponder systems, chips or modules, each antenna may be configured to respond to multiple distinct frequencies with regards to the requirements of each. For example, transponder (118) may be a 13.56 MHz transponder compliant with the ISO/IEC 14443 standard, and antenna (201) may be of the 13 MHz variety. The transponder (118) may be in communication with a transponder compatible modulator/demodulator (202) configured to receive the signal from transponder (118) and configured to modulate the signal into a format readable by any later connected circuitry. Further, modulator/demodulator (202) may be configured to format (e.g., demodulate) a signal received from the later connected circuitry in a format compatible with transponder (118) for transmitting to RFID reader (102) via antenna (201). For example, where transponder (118) is of the 13.56 MHz variety, modulator/demodulator (202) may be ISO/IEC 14443-2 compliant.

Modulator/demodulator (202) may be coupled to a protocol/sequence controller (203) for facilitating control of the authentication of the signal provided by RFID reader (102), and for facilitating control of the sending of the MDG card (101) account number. In this regard, protocol/sequence controller (203) may be any suitable digital or logic driven circuitry capable of facilitating determination of the sequence of operation for the MDG card (101) inner-circuitry. For example, protocol/sequence controller (203) may be configured to determine whether the signal provided by the RFID reader (102) is authenticated, and thereby providing to the RFID reader (102) the account number stored on MDG card (101), database (206).

Protocol/sequence controller (203) may be further in communication with authentication circuitry (204) for facilitating authentication of the signal provided by RFID reader (102). Authentication circuitry may be further in communication with a non-volatile secure memory database (205). Secure memory database (205) may be any suitable elementary file system such as that defined by ISO/IEC 7816-4 or any other elementary file system allowing a lookup of data to be interpreted by the application on the chip. Database (205) may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Database (206) may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

The data may be used by protocol/sequence controller (203) for data analysis and used for management and control purposes, as well as security purposes. Authentication circuitry (204) may authenticate the signal provided by RFID reader (102) by association of the RFID signal to authentication keys stored on database (205). Encryption circuitry may use keys stored on database (205) to perform encryption and/or decryption of signals sent to or from the RFID reader (102).

In addition, protocol/sequence controller (203) may be in communication with a database (206) for storing at least a MDG card (101) account data, and a unique MDG card (101) identification code. Protocol/sequence controller (203) may be configured to retrieve the account number from database (206) as desired. Database (206) may be of the same configuration as database (205) described above. The card account data and/or unique card identification code stored on database (206) may be encrypted prior to storage. Thus, where protocol/sequence controller (203) retrieves the account data, and or unique card identification code from database (206), the account number may be encrypted when being provided to RFID reader (102). Further, the data stored on database (206) may include, for example, an unencrypted unique MDG card (101) identification code, a user identification, Track 1 and Track 2 data, as well as specific application applets.

FIG. 3 illustrates an exemplary block diagram of a RFID reader (102) which may be used in accordance with an exemplary embodiment of the present invention. RFID reader (102) includes, for example, an antenna (104) coupled to a RF module (301), which is further coupled to a control module (302). In addition, RFID reader (102) may include an antenna (105) positioned remotely from the RFID reader (102) and coupled to RFID reader (102) via a suitable cable (111), or other wire or wireless connection.

RF module (301) and antenna (104) may be suitably configured to facilitate communication with an RF responsive transponder (118) contained in a card (101). Where MDG card (101) is formatted to receive a signal at a particular RF frequency, RF module (301) may be configured to provide an interrogation signal at that same frequency. For example, in one exemplary embodiment, MDG card (101) may be configured to respond to an interrogation signal of about 13.56 MHz. In this case, RFID antenna (104) may be 13 MHz and may be configured to transmit an interrogation signal of about 13.56 MHz.

RFID antenna (201) may be in communication with a transponder (303 via antenna 104) for transmitting an interrogation signal and receiving at least one of an authentication request signal and/or an account data from MDG card (101). Reader transponder (303) may be of similar description as card transponder (118 of FIG. 2). In particular, transponder (303) may be configured to send and/or receive RF signals in a format compatible with antenna (201) in similar manner as was described with respect to card transponder (118). For example, where transponder (303) is 13.56 MHz RF rated antenna (201) may be 13.56 MHz compatible. Similarly, where transponder (303) is ISO/IEC 14443 rated, antenna (104) may be ISO/IEC 14443 compatible.

RF module (301) may include, for example, transponder (303) in communication with authentication circuitry (304) which may be in communication with a secure database (305). Authentication circuitry (304) and database (305) may be of similar description and operation as described with respect to authentication circuitry (204) and secure memory database (205 of FIG. 2). For example, database (305) may store data corresponding to the MDG card (101) which are authorized to transact business over MDG card system (100). Database (305) may additionally store RFID reader (102) identifying information for providing to MDG card (101) for use in authenticating whether RFID reader (102) is authorized to be provided the MDG card (101) account number stored on card database (206).

Authentication circuitry (304) may be of similar description and operation as authentication circuitry (204). That is, authentication circuitry (304) may be configured to authenticate the signal provided by MDG card (101) in similar manner as authentication circuitry (204) may be configured to authenticate the signal provided by RFID reader (102). In accordance with the invention, MDG card (101) and RFID reader (102) engage in mutual authentication. In this context, “mutual authentication” may mean that operation of the MDG card system (100) may not take place until MDG card (101) authenticates the signal from RFID reader (102), and RFID reader (102) authenticates the signal from MDG card (101).

FIG. 4 illustrates an exemplary flow diagram for the operation of MDG card system (100). The operation may be understood with reference to FIG. 1, which depicts the elements of MDG card system (100) which may be used in an exemplary transaction involving the contactless card of the present invention. The process is initiated when a customer desires to present a contactless MDG card (101) for registry procedure or payment (step 401). Upon presentation of the MDG card (101), the merchant initiates the RF registry procedure or payment via an RFID reader (102), (step 402). In particular, the RFID reader sends out an interrogation signal to scan for the presence of MI)G card (101), (step 403). The RF signal may be provided via the RFID reader antenna (104) or optionally via an external antenna (105). Upon presenting the MDG card (101) for a registry procedure or payment (step 404), the MDG card (101) is activated by the RF interrogation signal provided.

The MDG card (101) and the RFID reader (102) may then engage in mutual authentication (step 405). Where the mutual authentication is unsuccessful, an error message may be provided to the customer via the RFID optical and/or audible indicator (step 407) and the transaction may be aborted (step 408). Where the mutual authentication is successful (step 406), the RFID reader (102) may provide the customer with an appropriate optical and/or audible message (e.g., “processing” or “wait”) (step 409). The card protocol/sequence controller (203) may then retrieve from database (206) an encrypted card data and provide the encrypted data to the RFID reader (102), (step 410).

The RFID reader (102) may then decrypt the data (step 411) and/or convert the data number into magnetic stripe (ISO/IEC 7813) format (step 412) and provide the unencrypted data to the registry and/or merchant system (115, 116), (step 413). In particular, the data may be provided to the POS Device (106) for transmission to the registry and/or merchant networks (107, 109) for processing under known business transaction standards. The POS Device (106) may then send an optical and/or audible transaction status message to the RFID reader (102), (step 414) for communication to the customer (step 415).

The preceding paragraphs describe in general an exemplary contactless MDG card system (100) which may be used with the present invention. It should be noted, however, that the present invention is not limited to the embodiment described. That is, any contactless and/or contact data transfer system which may be incorporated on the card may be used.

FIG. 5 illustrates an exemplary flow diagram of the operation of a registry procedure and MDG card update, in accordance with the present invention. A user initiating a registry procedure request over a network, from a user interface (501), for said registry procedure, in accordance with said request includes unique identifiers (502); prompting said user to physically interface MDG card (101) with a card reader system (102, 103), in accordance with said card comprises card data including unique identifiers (502); receiving said card information over a network coupled to said card reader system; sending an authentication request (503); transmitting data to registry (107); receiving an authentication (505); transmitting message and/or data to user interface (506); receiving authorization execute registry procedure (507); transmitting message and/or data to user interface (506); update MDG card (101), and completing said registry procedure and MDG card update.

FIG. 6 illustrates an exemplary flow diagram of the operation of updating database value fields of a durable good, in accordance with the present invention. The MDG card system (100) with the registry host network (107) maintains at least one database base value field (601) in a unit of measure possessing stable utility value, such as a unit of measure used for a globally traded commodity stated in a one year moving average (602), a unit of measure (603)(e.g. a unit for energy stated in mega joules), a weighted basket of currencies unit (e.g. International Monetary Fund Special Drawing Rights); which is updated periodically by factoring adjustment for the current global market value for the durable good since last update or sale (605); convert to local base value (607) by factoring appropriate exchange rate (606) for base unit used; determine credit limit value (609) field by multiplying said local base value (607) field by credit limit to base value ratio (608); determine credit limit to retail value ratio (611) field by dividing said credit limit value field (609) by retail price (610); update said database fields; and completing said updating card database value fields of a good.

FIG. 7 illustrates an exemplary flow diagram of the activation options (701) available through the MDG card system (100). The user may decide to activate the primary registry card feature only (702). Furthermore, the user may decide to activate the primary registry feature and add any additional feature(s) (703) such as monitoring of base value, monitoring of brand value, participation in exchange network, or other feature. In addition to obtaining the primary registry card, the user may wish to add the secondary credit card feature (704). Another option provided to the user is a card that includes the primary registry card, the secondary credit card feature and any additional features that the MDG card system (100) may offer (705).

FIG. 8 illustrates an exemplary embodiment of the present invention. The present invention includes, generally, a MDG card (101) may be comprised of base containing a multiple of layers which may not be visible from card's outer layers (801, 802) and multiple features affixed to the MDG card (101) such as text (803, 804, 805, 806, 807), a photograph (807), logos (808, 809, 810), embossed characters (811), magnetic stripe (812), signature field (813), holographic foil (814), RFID circuitry (815), and IC chips. Total size and thickness of the transaction MDG card (101) is within the ISO card size standard, namely about 2″.times.3.5″ and about 0.032 in. (32 mil.), which is within the ISO thickness standard for smart cards.

In an exemplary process, a user of the contactless MDG card (101) simply approaches an RF-based reader (102) when the user wishes interaction with the registry (107) for a registry procedure of a durable good and/or verification of good's registry status; or to conduct a transaction with merchant (109) using the card. The durable good to be registered, item to be purchased or the service to be performed may be entered into the RF-based reader (102) prior to, during and/or after presentation of the MDG card (101). The user simply waves in the air at a certain distance from the RF-based reader (102) until the RF-based reader (102) acknowledges that the information contained in the RFID circuitry has been transferred to the RF-based reader (102). The RF-based reader (102) then utilizes at least a portion of the information to complete the registry procedure and/or payment transaction (416). A user of the card may never need to relinquish control of the card to any other individual, such as the merchant's representative, or to any other person. In addition, a signature may not be required. However, a signature may be included, or some other form of authentication may be used for high-risk purchases, for example.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the preceding detailed description is presented for purposes of illustration only and not of limitation, and the scope of the invention is defined solely by the appended claims and their legal equivalents when properly read in light of the preceding description. For example, the steps recited in any of the method or process claims may be executed in any order and are not limited to the order presented.

### BRIEF DESCRIPTION OF DRAWINGS

FIG. 1 illustrates an exemplary card system in accordance the present invention.

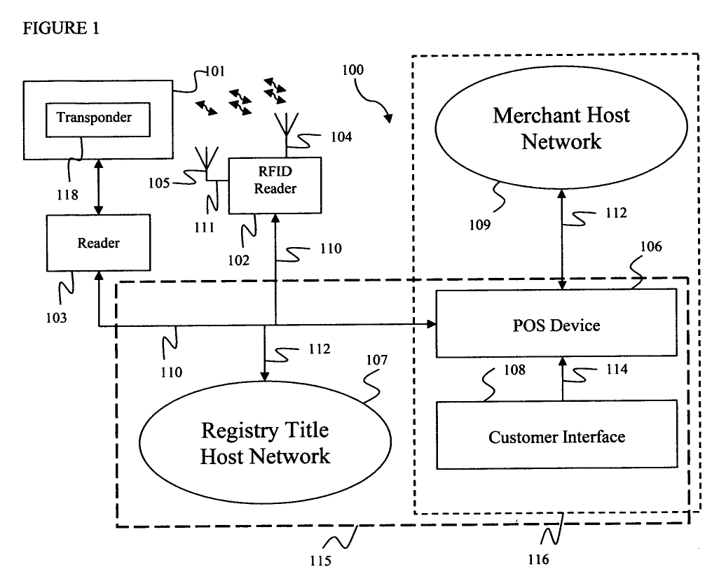

FIG. 2 illustrates an exemplary block diagram of an exemplary RFID transponder circuit for including in a contactless card in accordance with an exemplary embodiment of the present invention.

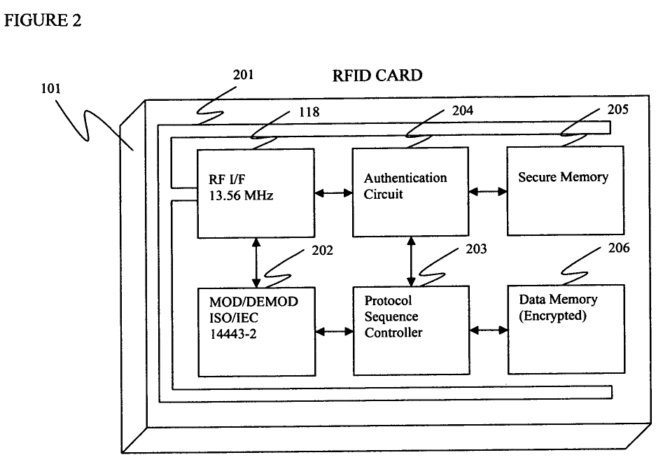

FIG. 3 illustrates an exemplary block diagram of an exemplary RFID reader in accordance with an exemplary embodiment of the present invention.

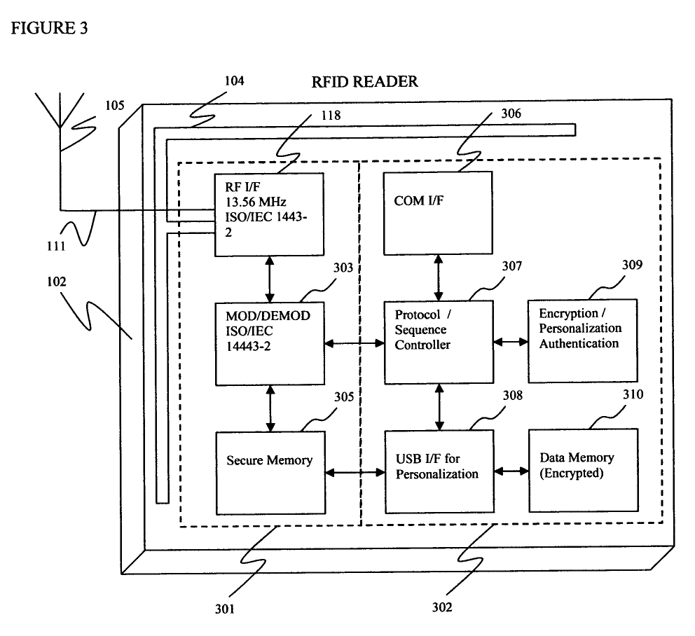

FIG. 4 illustrates an exemplary flow diagram of the operation of an exemplary RF card system in accordance with the present invention.

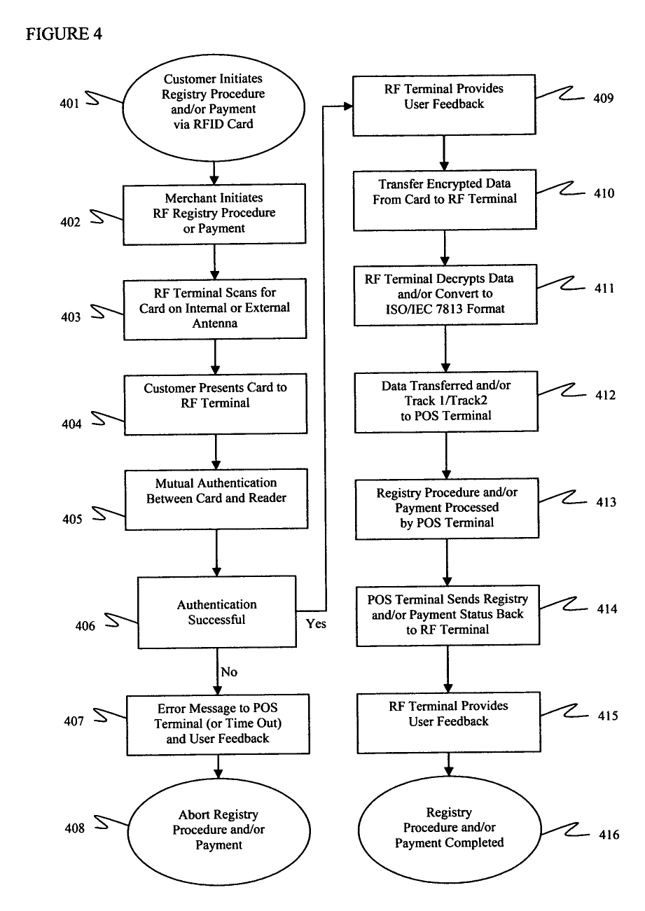

FIG. 5 illustrates an exemplary flow diagram of the operation of an exemplary registry procedure and card updating in accordance with the present invention.

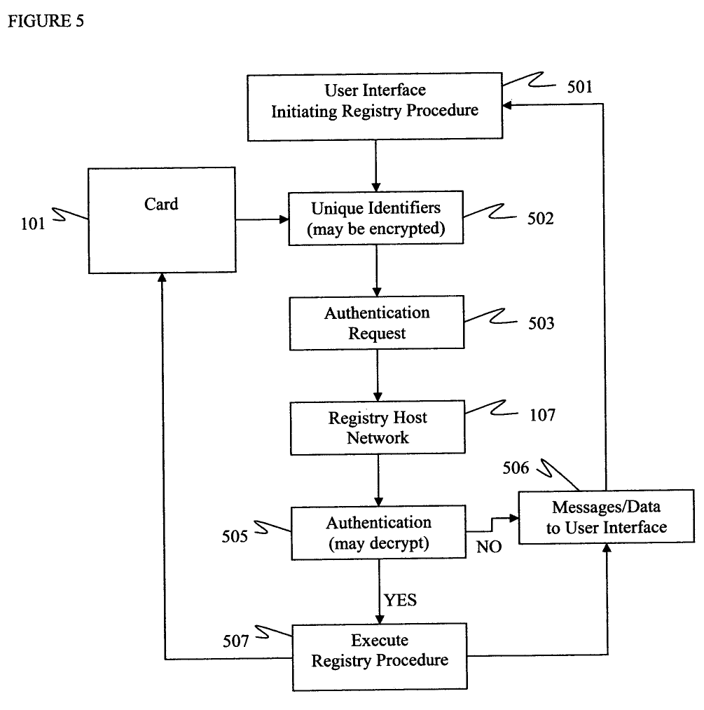

FIG. 6 illustrates an exemplary flow diagram of the operation of an exemplary updating of database value fields in accordance with the present invention.

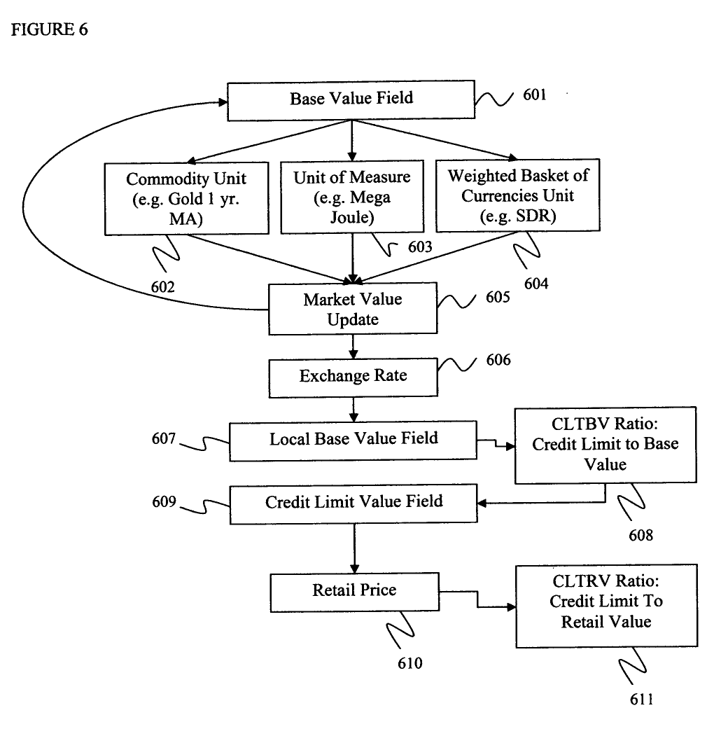

FIG. 7 illustrates an exemplary flow diagram of the activation options in accordance with the present invention.

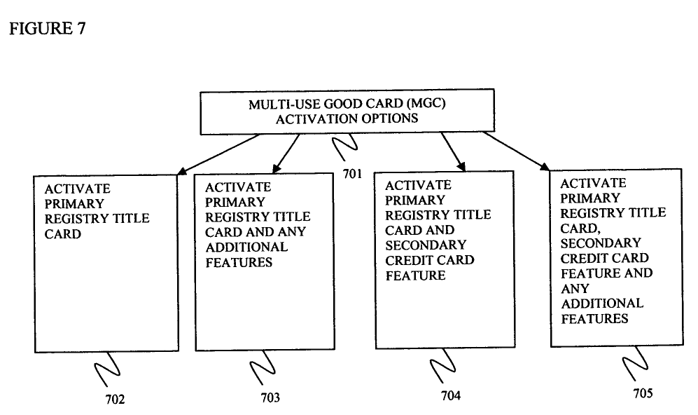

FIG. 8 depicts the front and rear surface of an exemplary card in accordance with an exemplary embodiment of the present invention.

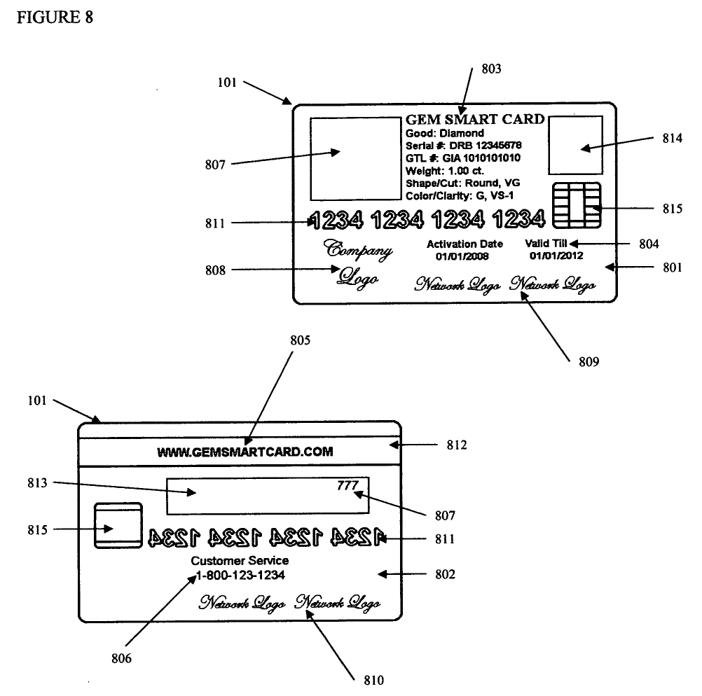

The invention claimed is:

1. A card, comprising: at least one of a holographic foil, a magnetic stripe, embossed characters, signature field, photograph and text and logo associated with said card; an integrated circuit, a biometric circuit; an RF transponder associated with said card and operable to receive a first RF interrogation signal, authenticate said first interrogation signal, and transmit a transponder account data.

2. The card of claim 1, in accordance with said card is a registry card and at least one of a transaction card, identification card, smartcard, credit card, charge card, access card, information storage card, and electronic commerce card.

3. The card of claim 1, in accordance with said card further comprising: a transponder authentication circuit in communication with said first transponder for authentication of a first verification data; and a transponder database for storing said transponder account data, said transponder database in communication with said first transponder.

4. The card of claim 3, further comprising: a second transponder associated with said card, said second transponder responsive to a second RE interrogation signal, said second transponder operable to receive a second RF interrogation signal, authenticate said second RF interrogation signal, and transmit said transponder account data; and receive a second RF interrogation signal, authenticate said second RF interrogation signal, and transmit said transponder account data; and an authentication circuit configured for authenticating a second verification data, said authentication circuit in communication with said second transponder.

5. The card of claim 4, further including a transponder protocol/sequence controller configured to control the order of operation of said first transponder, said second transponder, said transponder authentication circuit, and said transponder database, said protocol/sequence controller in communication with at least one of said first transponder, said second transponder, said transponder authentication circuit, and said transponder database.

6. The card of claim 4, further comprising at least one of a first transponder antenna and a second transponder antenna, said first transponder antenna configured to receive said first RF interrogation signal, and said second transponder antenna configured to receive said second RF interrogation signal.

7. The card of claim 5, in accordance with said transponder protocol/sequence controller is responsive to at least one of said first RF interrogation signal and said second RF interrogation signal, said transponder protocol/sequence controller controlling the sequence of operation at least one of said transponder authentication circuit, and said transponder database, in response to at least one of said first RF interrogation signal and said second RF interrogation signal.

8. The card of claim 5, in accordance with said transponder protocol/sequence controller is configured to activate said transponder authentication circuit in response to said first RF interrogation signal, said transponder authentication circuit configured to provide an encrypted RF interrogation signal, said transponder authentication circuit configured to provide said encrypted RF interrogation signal to said first transponder for providing to a RFID reader.

9. The card of claim 5, in accordance with said transponder database is operable to store at least one of a transponder identification data, a RFID reader decryption security key, and a transponder account data.

10. The card of claim 9, in accordance with said transponder database is configured to provide said RFID reader decryption security key to said transponder authentication circuit in response to an encrypted authentication code.

11. The card of claim 1, in accordance with said transponder may include an internal power source.

12. The card of claim 11, in accordance with said transponder includes a biometric circuit, said biometric circuit may communication with said internal power source.

13. The card of claim 12, in accordance with said biometric circuit is configured to provide a biometric data verification response, said biometric circuit configured to provide said biometric data verification response to at least one of said RFID reader and a network system, in accordance with said biometric data verification response is an identification verification data.

14. The card of claim 1, in accordance with said transponder comprises at least one antenna operable to receive said interrogation signal.

15. A card of claim 1, in accordance with said transponder is configured to provide information in magnetic stripe format.

16. A method comprising: a user initiating a registry of a durable good procedure request, over a network, from a user interface, for said registry procedure, in accordance with said request including card identifier; prompting said user to physically interface card with a card reader system, in accordance with said card comprises card data including unique identifiers; receiving said card information over a network coupled to said card reader system; sending an authentication request; receiving an authentication; transmitting data to registry; transmitting data to card; transmitting data to user interface; receiving authorization by registry; and completing said registry procedure.

17. The method of claim 16, further comprising updating database value fields of a durable good, such as base value, local value, and credit limit to value fields, in accordance with at least one database data field is maintained in a unit of measure possessing stable utility value, such as a unit of measure used for a globally traded commodity stated in a one year moving average, a unit of measure (e.g. mega joule), a weighted basket of currencies unit; factor adjustment for current global market value for the durable good since last update or sale; convert to local currency by factoring appropriate exchange rate for base unit used; determine base value credit limit field by multiplying said local value field by credit limit to base value ratio; determine retail value credit limit ratio field by dividing said credit limit value field by retail price; update said database fields; and completing said updating card database value fields of a durable good.

20. The method of claim 16, further comprising recording a change of title and/or liens on the title of a durable good, in accordance with registry host network receives request for change of title from user; registry host initiates authentication of user procedure; registry host receives unique user identifier, such unique identifier may be encrypted; such as a unique identifier from card, a biometric identifier from the biometric circuit on card; registry decrypts such unique identifier; registry requests user at user interface to submit to registry their unique identifier, which may be through biometric interface; registry authenticates by verifying a match between identifiers, from user, from card and held in registry record; change of title and/or lien inputted at user interface; registry record and card updated; and recording a change of title and/or lien on title of a durable good completed.

21. The card of claim 2, in accordance with said card is a financial instrument.
